(19) United States
(12) Patent Application Publication
(10) Pub. No.: US 2003/0080245 A1
(43) Pub. Date: May 1, 2003

(54) Self-inflated marine airship or balloon

(76) Inventor: Moshe Greenberg, Kiryat Ata (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/156,768

(22) Filed: May 29, 2002

(30) Foreign Application Priority Data
Nov. 1, 2001 (IL) 146292

(51) Int. Cl. B64B 1/24; B64D 37/00

(52) U.S. Cl. 244/61

(57) ABSTRACT

Self-inflated marine airship or balloon for producing hydrogen by separating it from water, using electrolyze process and electrical power that is produced by wind utilization. The marine is basically comprised of an air unit, i.e. the airship or the balloon, and of a water unit, that is a pod sunk in a water, e.g. lake water or sea water, and having a turbine driven electric generator. The water unit is harnessed to the air unit by cables, and when dragged by wind, the turbine drives the generator to produce electric power which is then being utilized to separate water molecules into oxygen and hydrogen which is in turn directed to the air unit through a pipe connection, for a storage.

### FIELD OF THE INVENTION

The present invention relates to a self-inflated marine airship or balloon for producing gas by the wind, using an electrolyze process. More specifically, the present invention relates to a self-inflated marine for producing hydrogen by separating it from water, using electrolyze process and electrical power that is produced by wind utilization.

### BACKGROUND OF THE INVENTION

One of the main future foreseen world problems is the limitation of the fossil energy resources; moreover the pollution caused by those fuels endangers the quality of life on earth. Therefore, there is a need for alternative clean energy source to replace the fossil energy.

The wind that is blowing in the ocean is a clean energy source that mankind has learned to use it in the very days. For generation the blowing wind was used to sail ships and rotate windmills.

The main object of the present invention is to use, again but in a different way, the blowing wind as a source of energy and an airship or balloon as storage of this energy wherein the energy is collected at sea and is used on land. The wind energy is transformed to electric power, by a generator, for electrolyzing water molecules into hydrogen. The hydrogen is occupied in lighter then air ship-container, which can be an airship or balloon. This container is carrying the sails and by itself is a high wind collector. The present invention is a self-inflated marine ocean airship or balloon that is a vessel that part of it is in the air while other part of it is in the water.

Separating water molecules (H₂O) can produce hydrogen and oxygen. Electrolyze is a well-known process for molecule separation, but this process needs large quantities of electrical power. Therefore, the efficiency of the electrolyze process depends on the availability of cheap electrical power source.

Various methods for producing cheap electrical power are known, usually by using utilities such as nature power, for example wind and stream water.

One of the elements of the present invention is an airship or balloon that is buoyant above the water and uses the wind and water to produce electrical power. U.S. Pat. No. 4,089,492 to Thoms describes an “Ocean Adapted Airship” which utilizes wind and water as a combination for self use electrical power production. In this patent, two groups of tension lines depending from the forward and aft portions of an airship are each connected to a separate vertically oriented elongate strut. The struts are dimensioned to extend through and below surface waves of a body of water. Optionally, electric thruster/generator units are mounted in pods on the bottom of the struts to either propel the airship or act as generators while drifting. Laterally reaching hydrofoils extend from the pods and either work to reduce drag or ensure responsive operation. The combination of the tension lines, struts, thruster/generator units and hydrofoils permits precise maneuvering at the surface for off-loading and on-loading at sea, allows for long endurance and range and gives a capability for operating as a quiet platform.

Another element of the present invention is an electrolyzer for converting energy to hydrogen gas. A method and apparatus for converting energy to hydrogen gas is described in U.S. Pat. No. 5,512,145 “Energy Conversion Self-inflated marine” to Hollenberg. This invention relates to a method and apparatus for converting energy to hydrogen gas using an electrolyzer and a metal alloy hydride tank for hydrogen storage, wherein a passive load matching device between the energy source and the electrolyzer maximizes hydrogen output, and the electrolyzer and the metal alloy hydride tank operate at mutually low pressure, near ambient, such that pressurization of the self-inflated marine is not required.

In general, the present invention is a self-inflated marine that is made like a balloon or airship which drags a pod that is sunk in the water, an electric generator mounted in the pod for generating electrical power while drifting and an electrolyzer that uses the electrical power for separating hydrogen from water and collects the produced hydrogen in the balloon or in the airship.

### SUMMARY OF THE INVENTION

The present invention is a self-inflated marine for producing hydrogen.

According to the teachings of the present invention there is provided a self-inflated marine for producing hydrogen, the self-inflated marine includes:

(a) an inflatable balloon or airship, which is capable of flying or being dragged by the wind, is enabled to store hydrogen inside. The balloon or airship has an inlet and an outlet which is enabled to fill and to discharge of the hydrogen from the balloon or airship;

(b) at least one turbine, to be sunk in water, is rotated by a power of water, whether by running water or by stagnant water while the turbine is drifted through said stagnant water;

(c) at least one generator, each of the generators is driven by one of the turbines for producing electrical power; and

(d) at least one electrolyzing unit for electrolyzes hydrogen from water, using the electrical power.

According to a preferred embodiment of the present invention, it is providing a self-inflated marine for producing hydrogen, wherein the balloon or airship is connected to the turbine by ropes, enabling the buoyancy of the balloon or airship—according to Archimedes law—and drags the turbine through the water while the balloon or airship is dragged by the wind.

According to another preferred embodiment of the present invention, it is provided a self-inflated marine for producing hydrogen, further includes:

(e) navigating sub-self-inflated marine, enable navigating the self-inflated marine in a predetermined track.

According to another preferred embodiment of the present invention it is provided a self-inflated marine for producing hydrogen, further includes:

(f) at least one wind collecting element for driving the self-inflated marine by force of wind, while at least the turbine is sunk in water.

According to another preferred embodiment of the present invention it is provided a self-inflated marine for producing hydrogen, further includes:

(g) a controller, the controller is operative for managing, controlling and navigating the self-inflated marine.

According to another preferred embodiment of the present invention it is provided a self-inflated marine for producing hydrogen, further includes a controller for controlling the electrolyze.

According to another aspect of the present invention there is provided a self-inflated marine for producing hydrogen including:

(a) at least one water-unit, the water unit includes:

(i) a turbine;

(ii) a generator, the generator is driven by the turbine;

(iii) at least one electrolyzing unit for electrolyze hydrogen from water; and

(iv) a controller; and wherein the water-unit either is sunk in water or is floating on water wherein at least the turbine is sunk in water;

(b) an inflatable balloon or airship to store the electrolyzed hydrogen, the balloon or airship which is airship shaped and has an outlet with a valve enables to collect the hydrogen from the balloon or airship;

(c) ropes that are harnessed to the water-unit and the balloon or airship, enabling the buoyancy of the balloon or airship—according to Archimedes law—which is dragged by force of the wind, while the water-unit with the turbine is sunk in water; and

(e) at least one pipe, each pipe is connected from each of the electrolyzing unit to the balloon or airship, enabling the electrolyzed hydrogen to flow into the balloon or airship.

According to yet another aspect of the present invention there is provided a method for producing hydrogen which includes the following steps:

(a) sinking a turbine in water;

(b) harnessing the turbine to an inflatable balloon or airship that is partly filled with hydrogen;

(c) allowing the balloon or airship to be dragged by the wind, the balloon or airship drags the turbine through the water and the turbine is spinning;

(d) using the turbine spin to drive a generator;

(e) using the power of the generator for electrolyzing hydrogen from water;

(f) collecting the electrolyzed hydrogen into the balloon or airship; and

(g) discharging produced hydrogen from the balloon or airship.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates an embodiment of the self-inflated marine for producing hydrogen, according to the present invention.

FIG. 2 illustrates an embodiment of a water unit that is sunk in the water.

### DESCRIPTION OF THE PREFERED EMBODIMENTS

The present invention is a self-inflated marine for producing hydrogen.

In a preferred embodiment there is a water unit, optionally a pod, which is sunk in water. The water unit includes a turbine, a generator and an electrolyzer. While the water unit is dragged through water, the turbine is spinning the generator that produces electrical power, which is used by the electrolyzer to separate hydrogen from water.

The water unit is connected to an airship by means of ropes. While the airship is dragged by wind, the ropes drag the water unit, the water spins the turbine, which spins the generator for producing electrical power that is used by the electrolyzer for producing hydrogen.

The produced hydrogen flows, by means of pipe, into the airship and the hydrogen can by collected from the airship.

The principles and operation of the self-inflated marine according to the present invention may be better understood with reference to the drawing and the accompanying description.

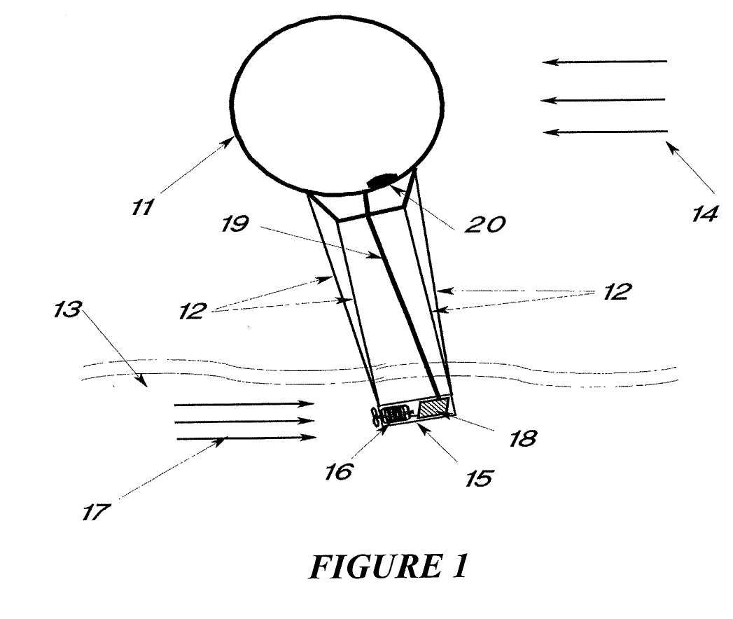

Referring now to the drawing, FIG. 1 illustrates an embodiment of the self-inflated marine for producing hydrogen, according to the present invention. A balloon 11 is floating in the air, a water unit 15 is connected to the balloon 11 by means of ropes 12 and the water unit 15 is sunk in the ocean 13. Wind 14 drifts the balloon 11 and the ropes 12 drag the water unit 15 in the water 17. The water unit has a generator with turbine 16 and electrolyzer 18. While the water unit 15 is being dragged through the water 17, this spins the generator 16, which supplies electrical power to the electrolyzer 18 for producing hydrogen from water molecules H₂O. The produced hydrogen flows through a pipe 19 into the balloon 11 and can be collected from the balloon 11 by means of a valve 20.

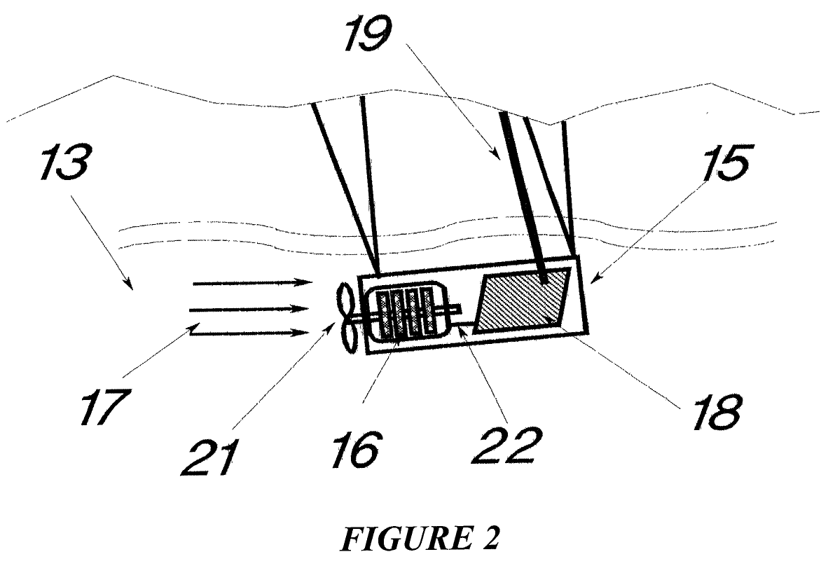

FIG. 2 illustrates an embodiment of a water unit that is sunk in the water. The water unit 15 is sunk in the ocean 13 and includes a turbine 21 that is spinning while the unit 15 is being dragged through the water 17. The turbine spins the generator 16, which produces electrical power, which is supplied by means of cable 22 to an electrolyzer 18. The electrolyzer 18 produces hydrogen by using electrolyzes process for separating water molecules into hydrogen and oxygen. The produced hydrogen flows through a pipe 19 into the balloon, which acts as a temporary container.

Although the invention has been described in conjunction with specific embodiments thereof, it is evident that many alternatives, modifications and variations will be apparent to those skilled in the art accordingly, it is intended to embrace all such alternatives, modifications and variations that fall within the spirit and broad scope of the appended claims.

What is claimed is:

1. A self-inflated marine for producing hydrogen, said self-inflated marine comprising:
(a) an inflatable balloon or airship capable to fly in the air and be dragged by wind, said balloon or airship enables to store hydrogen inside and said balloon or airship has an inlet and an outlet enables to fill and to discharging said hydrogen from said balloon or airship;
(b) at least one turbine, to be sunk in water, said turbine is rotated by a power of water, whether by running water or by stagnant water while said turbine is drifted through said stagnant water;
(c) at least one generator, each of said generators is driven by one of said turbines for producing electrical power; and
(d) at least one electrolyzing unit for electrolyzes hydrogen from water, using said electrical power.

2. The self-inflated marine of claim 1 wherein said balloon or airship is connected to said turbine by ropes, enabling the buoyancy of said balloon or airship—according to Archimedes law—and drags said turbine through the water while said balloon or airship is dragged by wind.

3. The self-inflated marine of claim 1 further comprising:
(e) navigating sub-self-inflated marine, enables navigating said self-inflated marine in a predetermined track.

4. The self-inflated marine of claim 1 further comprising:
(f) at least one wind-collecting element for driving said self-inflated marine by force of wind, while at least said turbine is sunk in water.

5. The self-inflated marine of claim 1 further comprising:
(g) a controller, said controller is operative for managing, controlling and navigating said self-inflated marine.

6. The self-inflated marine of claim 1 wherein said electrolyze unit further includes a controller for controlling said electrolyze.

7. A self-inflated marine for producing hydrogen, said self-inflated marine comprising:
(a) at least one water-unit, said water unit comprised of:
(i) a turbine;
(ii) a generator, said generator is driven by said turbine;
(iii) at least one electrolyzing unit for electrolyze hydrogen from water; and
(iv) a controller;
and wherein said water-unit either is sunk in water or floating on water wherein at least said turbine is sunk in water;
(b) an inflatable balloon or airship to store said electrolyzed hydrogen, said balloon or airship is airship shaped and having an outlet with valve enables to collect said hydrogen from said balloon or airship;
(c) ropes that are harnessed to said water-unit and said balloon or airship, enabling the buoyancy of said balloon or airship—according to Archimedes law—and drags by force of wind said water-unit while at least said turbine is sunk in water; and
(e) at least one pipe, each pipe is connected from each of said electrolyzing unit to said balloon or airship, enabling said electrolyzed hydrogen to flow into said balloon or airship.

8. A method for producing hydrogen comprising:
(a) sinking a turbine into water;
(b) harnessing said turbine to an inflatable balloon or airship that is partly filled with hydrogen;
(c) allowing said balloon or airship to be drag by wind, said balloon or airship drags said turbine inside water and the turbine is spinning;
(d) using the turbine spin to drive a generator;
(e) using the power of said generator for electrolyzing hydrogen from water;
(f) collecting said electrolyzed hydrogen into said balloon or airship; and
(g) discharging produced hydrogen from said balloon or airship.
